(19) United States
(12) Patent Application Publication
(10) Pub. No.: US 2016/0209563 A1
(43) Pub. Date: Jul. 21, 2016

(54) ANTIREFLECTIVE FILM FOR FLEXIBLE DISPLAY DEVICE AND FLEXIBLE DISPLAY DEVICE INCLUDING THE SAME

(71) Applicants: Samsung Electronics Co., Ltd., Suwon-si (KR); SAMSUNG SDI CO., LTD., Yongin-si (KR)

(72) Inventors: Hye Young KONG, Uijeongbu-si (KR); Hyung Jun KIM, Suwon-si (KR); Jong Hoon WON, Yongin-si (KR); Seung Jun LEE, Suwon-si (KR); Woo Jin JEONG, Suwon-si (KR); Myung Sup JUNG, Seongnam-si (KR); Hyun-Seok CHOI, Anyang-si (KR)

(21) Appl. No.: 14/747,075

(22) Filed: Jun. 23, 2015

(30) Foreign Application Priority Data
Jan. 15, 2015 (KR) 10-2015-007461

(51) Int. Cl. G02B 5/30; B32B 27/36; G02B 1/11; B32B 27/32; B32B 27/20; B32B 27/08; B32B 27/30

(52) U.S. Cl. CPC G02B 5/305; B32B 27/08; B32B 27/365; B32B 27/308; B32B 27/32; B32B 27/20; G02B 1/11; G02B 5/3083; B32B 2250/24; B32B 2307/42; B32B 2457/20

(57) ABSTRACT

An antireflective film for a flexible display device includes a polarizing film, a compensation film, and an adhesion layer positioned therebetween, and, the antireflective film has a retardation change (ΔR) relative to initial retardation (R₀) satisfying the following Equation 1 when bent with a curvature radius (r) of greater than or equal to about 3 mm:

$$\frac{Δ R}{{R}_{0}} \times 100 \leq 10 \% . \qquad Equation 1$$

### CROSS-REFERENCE TO RELATED APPLICATION

This application claims priority to Korean Patent Application No. 10-2015-0007461, filed in the Korean Intellectual Property Office on Jan. 15, 2015, and all the benefits accruing therefrom under 35 U.S.C. §119, the content of which is incorporated herein in its entirety by reference.

### BACKGROUND

1. Field

An antireflective film for a flexible display device and a flexible display device including the same are disclosed.

2. Description of the Related Art

A display device such as a liquid crystal display (LCD) and an organic light emitting diode (OLED) device include a polarizing plate attached to the outside of a display panel. The polarizing plate transmits light within a specific wavelength range and a selected plane of incidence and absorbs or reflects light of any other wavelength and plane of incidence, thus controlling the direction of incident light in the display panel or light emitted from the display panel.

The polarizing plate generally includes a polarizer and a protective layer for the polarizer. The polarizer may include, for example, iodine or a dichroic dye adsorbed and arranged on polyvinyl alcohol (PVA), and the protective layer may use, for example, triacetyl cellulose (TAC).

The polarizing film may be combined with a compensation film and thus function as an antireflective film preventing reflection of externally incident light. The antireflective film may be formed on one side or both sides of a display device and thus have an influence on visibility of light emitted from the display device.

On the other hand, a flexible display device may realize a large-sized and portable screen. The flexible display device is variously used for a TV, a monitor, and the like, as well as mobile equipment such as a mobile phone, a portable media player (PMP), a navigator, an electronic book, or an electronic newspaper. In order to drive development of the flexible display device, antireflective films must exhibit excellent flexibility performance. The flexible display device is expected to be in increased demand, as the consumer expectation for portability of display devices is increased. Accordingly, development of an antireflective film having excellent flexibility performance is required while maintaining optical properties as a polarizing film.

### SUMMARY

An embodiment provides an antireflective film for a flexible display device having a minor retardation difference in a bent region, without generating delamination phenomenon or vapor in the bent region, and thus being useful for application to flexible display devices.

Another embodiment provides a flexible display device equipped with the antireflective film.

According to an embodiment, an antireflective film for a flexible display device includes a polarizing film, a compensation film, and an adhesion layer positioned therebetween, wherein the retardation change (ΔR) of the antireflective film relative to initial retardation (R₀) satisfies the following Equation 1 when the antireflective film is bent with a curvature radius (r) of greater than or equal to about 3 mm:

$$\frac{Δ R}{{R}_{0}} \times 100 \leq 10 \% . \qquad Equation 1$$

wherein the ΔR/R₀ percentage is less than or equal to about 10%, for example less than or equal to about 8% when the curvature radius is about 3 mm, or is less than or equal to about 8%, for example less than or equal to about 4% when the curvature radius is about 5 mm.

The polarizing film includes a dichroic dye and a polymer resin.

The compensation film may be a quarter wave (λ/4) retardation film.

The adhesion layer may include a polymeric adhesive containing a polymer selected from an acrylate polymer, a methacrylate polymer, a urethane polymer, a polyisobutylene, a styrene butadiene polymer, a polyvinylether polymer, an epoxy polymer, a melamine polymer, a polyester, a phenolic polymer, a silicone, or a combination thereof.

The polymeric adhesive may include at least one functional group selected from a hydroxy group, a carboxyl group, and a nitrogen-containing functional group.

The polymeric adhesive may be cross-linked with at least one cross-linking agent selected from an isocyanate compound, an epoxy compound, an aziridine compound, and a metal chelate compound.

The polymeric adhesive may have a weight average molecular weight (Mw) ranging from about 500,000 to about 1,800,000 and an acid value ranging from about 0.5 to about 16.

When the adhesive resin has a weight average molecular weight of greater than or equal to about 1,500,000, the acid value may be greater than or equal to about 4.5.

The adhesion layer may have a 180° (degrees) peeling strength of greater than or equal to about 800 gram force (gf)/25 mm from a polyolefin substrate, and of greater than or equal to about 700 gf/25 mm from a polycarbonate substrate, when tested at room temperature (about 25° C.). In addition, the adhesion layer may have a 180° peeling strength of greater than or equal to about 400 gf/25 mm from a polyolefin substrate, and of greater than or equal to about 1700 gf/25 mm from a polycarbonate substrate, when tested at a high temperature (about 60° C. to about 85° C.).

The adhesion layer may have a ratio (G″/G′) of a loss modulus (G″, ω=100) of greater than or equal to about 0.5 relative to a storage modulus (G′, ω=0.1) under a thickness condition of 500 μm.

According to another embodiment, a flexible display device includes a display panel and an antireflective film formed on at least one side of the display panel, wherein the antireflective film includes a polarizing film, a compensation film, and an adhesion layer therebetween, and a retardation change (ΔR) of the antireflective film relative to the initial retardation (R₀) satisfies the following Equation 1 when the antireflective film is bent with a curvature radius (r) of greater than or equal to about 3 mm:

$$\frac{Δ R}{{R}_{0}} \times 100 \leq 10 \% . \qquad Equation 1$$

The flexible display device may include an organic light emitting diode (OLED) display and a liquid crystal display (LCD).

### BRIEF DESCRIPTION OF THE DRAWINGS

These and/or other aspects will become apparent and more readily appreciated from the following description of the embodiments, taken in conjunction with the accompanying drawings in which

FIG. 1 is a schematic view showing an antireflective film for a flexible display device according to an exemplary embodiment,

FIG. 2 is a cross-sectional view of an organic light emitting diode (OLED) display according to an exemplary embodiment,

FIG. 3 is a plan view showing a bending test method of the antireflective films according to Examples 1 and 2 and Comparative Example 1,

FIG. 4 is a photograph showing the cross-section of the antireflective film according to Example 1, when allowed to stand at 60° C. under relative humidity of 95% for 250 hours in a curvature radius state of about 3 mm,

FIG. 5 is a photograph showing the cross-section of the antireflective film according to Example 2, when allowed to stand at 60° C. under relative humidity of 95% for 250 hours in a curvature radius state of about 5 mm, and

FIG. 6 is a photograph showing the cross-section of the antireflective film according to Comparative Example 1, when allowed to stand at 60° C. under relative humidity of 95% for 250 hours in a curvature radius state of about 5 mm.

### DETAILED DESCRIPTION

Exemplary embodiments will hereinafter be described in detail, and may be easily performed by those who have common knowledge in the related art. However, this disclosure may be embodied in many different forms and is not to be construed as limited to the exemplary embodiments set forth herein.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

Parts having no relationship with the description may be omitted for clarity, and the same or similar constituent element is indicated by the same reference numeral throughout the specification.

As used herein, when a definition is not otherwise provided, the term “substituted” refers to a named compound or group on which a hydrogen atom is not present, being replaced by a substituent selected from a halogen atom (F, Br, Cl, or I), a C1 to C20 alkoxy group, a cyano group, an amino group, a C1 to C20 ester group, a C1 to C20 alkyl group, a C2 to C20 alkenyl group, a C2 to C20 alkynyl group, a C6 to C20 aryl group, a C1 to C20 heteroaryl group, and a combination thereof.

Hereinafter, an antireflective film for a flexible display device according to an embodiment is described.

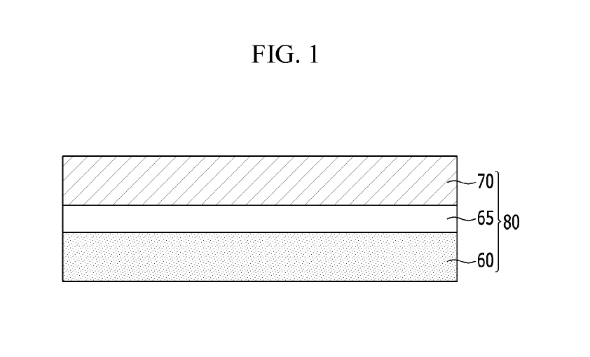

FIG. 1 is a schematic view showing an antireflective film for a flexible display device according to an embodiment.

Referring to FIG. 1, an antireflective film 80 for a flexible display device according to an embodiment includes a compensation film 60, a polarizing film 70, and an adhesion layer 65 disposed therebetween, wherein a retardation change (ΔR) of the antireflective film 80 relative to initial retardation (R₀) satisfies the following Equation 1 when bent with a curvature radius (r) of greater than or equal to about 3 mm.

$$\frac{Δ R}{{R}_{0}} \times 100 \leq 10 \% \qquad Equation 1$$

Herein, the ΔR/R₀ percentage may be less than or equal to about 10%, for example less than or equal to about 8% when the curvature radius is about 3 mm, or is less than or equal to about 8%, for example less than or equal to about 4% when the curvature radius is about 5 mm. This retardation variation ratio may be calculated by measuring retardation in the center of the bent region after the antireflective film is bent to the specified curvature radius and allowed to stand for a predetermined time in a bent state.

The compensation film 60 may be a retardation film, for example a λ/4 retardation film. The compensation film 60 circularly polarizes light passing through the polarizing film 70 and generates retardation, and thus has an influence on reflection and absorption of the light.

The compensation film 60 may be a film having a retardation function without limitation. For example, the compensation film 60 may be made of a polymer such as a cycloolefin polymer (COP), an acrylate polymer, a polystyrene, a polyester, a cellulose, a polycarbonate, or a combination thereof.

The compensation film 60 may have a thickness ranging from about 5 μm to about 100 μm, for example about 10 μm to about 50 μm. When the compensation film 60 is applied to the antireflective film 80 for a flexible display device, it may provide an optical compensation effect and retard incident light at a retardation value of λ/4.

The compensation film 60 may be a forward wavelength retardation film or a reverse wavelength retardation film.

The polarizing film 70 includes a dichroic dye and a polymer.

As for the dichroic dye, iodine or a dichroic organic dye may be used. The dichroic organic dye may be, for example, an azo-group containing compound, an anthraquinone compound, a phthalocyanine compound, an azomethine compound, an indigoid or thioindigoid compound, a merocyanine compound, a 1,3-bis(dicyanomethylene)indan compound, an azulene compound, a quinophthalonic compound, a triphenodioxazine compound, an indolo[2,3,b]quinoxaline compound, an imidazo[1,2-b]-1,2,4-triazine compound, a tetrazine compound, a benzo compound, a naphthoquinone compound, or a compound having a combined molecular backbone of the foregoing compounds.

The azo-group containing compound may be, for example, a compound represented by Chemical Formula 1.

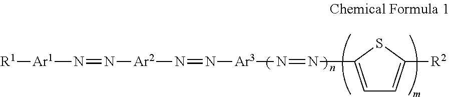

In Chemical Formula 1,

Ar¹ to Ar³ are each independently a substituted or unsubstituted C6 to C15 arylene group,

R¹ is a substituted or unsubstituted C1 to C30 aliphatic organic group, a substituted or unsubstituted C6 to C30 aromatic organic group, a substituted or unsubstituted C1 to C30 hetero aliphatic organic group, a substituted or unsubstituted C3 to C30 hetero aromatic organic group, or a combination thereof,

R² is hydrogen, a substituted or unsubstituted C1 to C30 aliphatic organic group, a substituted or unsubstituted C6 to C30 aromatic organic group, a substituted or unsubstituted C1 to C30 hetero aliphatic organic group, a substituted or unsubstituted C3 to C30 hetero aromatic organic group, a substituted or unsubstituted amino group, or a combination thereof, and

n and m are independently 0 or 1.

The polymer may be a hydrophobic polymer resin, for example a polyolefin resin such as polyethylene (PE), polypropylene (PP), and a copolymer thereof; a polyamide resin such as nylon and an aromatic polyamide; a polyester such as polyethylene terephthalate (PET), polyethylene terephthalate glycol (PETG), and polyethylene naphthalate (PEN); a polyacrylic such as polymethyl(meth)acrylate; a polystyrene such as polystyrene (PS) and an acrylonitrile-styrene copolymer; a polycarbonate; a polyvinylchloride; a polyimide; a polysulfone; a polyethersulfone; a polyether-ether ketone; a polyphenylene sulfide; a polyvinyl alcohol; a polyvinylidene chloride; a polyvinylbutyral; a polyallylate; a polyoxymethylene; an epoxy polymer; a copolymer thereof; or a combination thereof.

In one embodiment, the polymer may be, for example, polyethylene (PE), polypropylene (PP), polyethylene terephthalate (PET), polyethylene terephthalate glycol (PETG), polyethylene naphthalate (PEN), nylon (polyamide), a copolymer thereof, or a combination thereof.

The polymer may be, for example, a mixture of at least two selected from polyethylene (PE), polypropylene (PP), and a copolymer of polyethylene and polypropylene (PE-PP), and for another example, a mixture of polypropylene (PP) and a polyethylene-polypropylene copolymer (PE-PP).

The dichroic dye is dispersed in the polymer, and is aligned in the elongation direction of the polymer. The dichroic dye is a material that transmits one perpendicular polarization component of two perpendicular polarization components in a predetermined wavelength region.

The dichroic dye may be included in an amount of about 0.1 to about 10 parts by weight based on 100 parts by weight of the polymer. When the dichroic dye is included within the range, sufficient polarization characteristics may be obtained without deteriorating transmittance of a polarizing film. Within the range, the dichroic dye may be included in an amount of about 0.05 to about 5 parts by weight based on 100 parts by weight of the polymer.

The polarizing film 70 may have, for example, a dichroic ratio of greater than or equal to about 2 to about 14 at about 450 nm to about 550 nm. The polarizing film 70 may have, for example, a dichroic ratio of greater than or equal to about 2 to about 14 at about 380 nm to 650 nm.

The polarizing film 70 may have, for example, a dichroic ratio of greater than or equal to about 2.3, for example greater than or equal to about 2.5, within the range. The higher dichroic ratio the polarizing film 70 has, the better it is, but the dichroic ratio may be, for example, less than or equal to about 20, less than or equal to about 14, less than or equal to about 10, less than or equal to about 8, or less than or equal to about 6.

The polarizing film 70 may have light transmittance of greater than or equal to about 30%, for example about 30% to about 95%. When the polarizing film 70 has light transmittance within the ranges, it may not interrupt emission of light emitting out of a display device when applied to one side of the display device.

The polarizing film 70 may be a melt blend of the polymer and the dichroic dye. The melt blend may be prepared by melt-blending the polymer and the dichroic dye at a temperature of greater than or equal to the melting point (Tₘ) of the polymer.

For example, the polarizing film 70 may be prepared by melt-blending the polymer and the dichroic dye and elongating the same. For another example, the polarizing film 70 may be prepared by a process including melt-blending the polymer and the dichroic dye, putting the melt blend into a mold and compressing it into a sheet, and elongating the sheet in a uniaxial direction.

The polarizing film 70 may have a relatively thin thickness of less than or equal to about 100 μm, for example about 30 μm to about 95 μm. When the polarizing film 20 has a thickness within the range, it may be significantly thinner than a polarizing plate requiring a protective layer such as triacetyl cellulose (TAC), and may contribute to realizing a thin display device.

The adhesion layer 65 may be positioned between the compensation film 60 and the polarizing film 70.

The adhesion layer 65 may include a polymeric adhesive selected from an acrylate polymer, a methacrylate polymer, a urethane polymer, a polyisobutylene polymer, a styrene butadiene polymer, a polyvinylether polymer, an epoxy polymer, a melamine polymer, a polyester polymer, a phenolic polymer, a silicone polymer, or a combination thereof. In one embodiment, the polymeric adhesive may be formed from a polymer that includes at least one functional group selected from a hydroxy group, a carboxyl group, and a nitrogen-containing functional group. In one embodiment, the polymeric adhesive may be cross-linked with at least one cross-linking agent selected from an isocyanate compound, an epoxy compound, an aziridine compound, and a metal chelate compound.

The polymeric adhesive may have a weight average molecular weight (Mw) ranging from about 500,000 to about 1,800,000, for example about 600,000 to about 1,500,000. In addition, the polymeric adhesive may have an acid value ranging from about 0.5 to about 16, for example, about 2.0 to about 15. Particularly, when the polymeric adhesive has a weight average molecular weight of greater than or equal to about 1,500,000, the acid value of greater than or equal to about 4.5, for example, ranging from about 4.5 to about 16, may be more advantageous. When the weight average molecular weight and the acid value are respectively included within the ranges, a retardation variation ratio corresponding to Equation 1 may be adjusted to be less than or equal to about 10%.

The adhesion layer 65 may have 180° peeling strength of greater than or equal to about 800 gf/25 mm from a polyolefin substrate, and of greater than or equal to about 700 gf/25 mm from a polycarbonate substrate, when tested at room temperature (about 25° C.). In addition, the adhesion layer 65 may have 180° peeling strength of greater than or equal to about 400 gf/25 mm from a polyolefin substrate, and of greater than or equal to about 1700 gf/25 mm from a polycarbonate substrate, when tested at a high temperature (about 60° C. to about 85° C.). The peeling strength is based on a 10 μm thickness of the adhesion layer 65. When the peeling strength is within the described range, the adhesion performance of the adhesion layer 65 may be easily adjusted within a desired range.

The adhesion layer 65 may have a ratio (G″/G′) of a loss modulus (G″, ω=100) of greater than or equal to about 0.5 relative to a storage modulus (G′, ω=0.1), for example, a ratio (G″/G′) ranging from about 0.7 to about 1.7 under a thickness condition of about 500 μm. Within the described range of (G″/G′) ratios, the adhesion performance of the adhesion layer 65 may be easily adjusted within a desired range.

The adhesion layer 65 may have a thickness ranging from about 5 μm to 25 μm, and for example, about 7 μm to about 20 μm. Within the described thickness range, the adhesion and the peeling strength of the adhesion layer 65 may be easily adjusted within a desired range.

The adhesion layer 65 may be formed by coating a solution including a polymeric adhesive on at least one of the compensation film 60 or the polarizing film 70 and curing it, or by forming a polymeric adhesive into a film and disposing the film between the compensation film 60 and the polarizing film 70 and then bonding them through lamination.

The antireflective film 80 for a flexible display device may be formed on one side or both sides of the flexible display device, and particularly, on the screen side of the flexible display device, and thus prevents reflection of incident light (hereinafter called “external light”) from the outside. Accordingly, the antireflective film 80 may prevent visibility deterioration due to the reflection of external light.

The antireflective film 80 for a flexible display device may be applied to various flexible display devices.

The display device may be, for example, an organic light emitting diode (OLED) display or a liquid crystal display (LCD), but is not limited thereto.

According to an embodiment, the flexible display device includes a display panel, and the aforementioned antireflective film for a flexible display device equipped on at least one side of the display panel.

The display panel may include, for example, two substrates facing each other with an active layer disposed therebetween, and for example may include a liquid crystal panel or an organic light emitting panel.

The antireflective film for a flexible display device may include a polarizing film, a compensation film, and an adhesion layer disposed therebetween as described above, and for example, is the same as described above.

Hereinafter, an organic light emitting diode (OLED) display as an exemplary embodiment of the display device is illustrated.

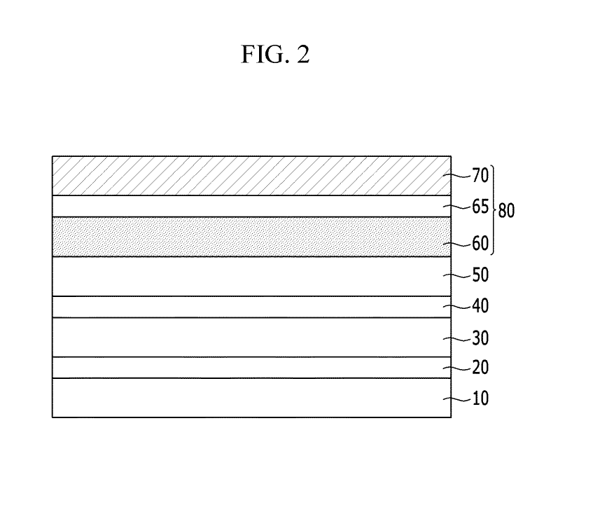

FIG. 2 is a cross-sectional view showing an organic light emitting diode (OLED) display according to an exemplary embodiment.

Referring to FIG. 2, an organic light emitting diode (OLED) display according to an embodiment includes a base substrate 10, a lower electrode 20, an organic emission layer 30, an upper electrode 40, an encapsulation substrate 50, and an antireflective film 80. As described above, the antireflective film 80 includes a compensation film 60, a polarizing film 70, and an adhesion layer 65 positioned therebetween.

The base substrate 10 may be made of a silicon wafer, glass or plastic, and the like.

Either of the lower electrode 20 or the upper electrode 40 may be an anode, while the other is a cathode. The anode is an electrode where holes are injected, and is formed of a transparent conductive material having a high work function and externally transmitting entered light, for example, indium-doped tin oxide (ITO) or indium zinc (IZO). The cathode is an electrode where electrons are injected, is formed of a conducting material having a low work function and having no influence on an organic material, and is selected from, for example, aluminum (Al), calcium (Ca), and barium (Ba).

The organic emission layer 30 includes an organic material which emits light when a voltage is applied between the lower electrode 20 and the upper electrode 40.

An auxiliary layer (not shown) may be further included between the lower electrode 20 and the organic emission layer 30 and between the upper electrode 40 and the organic emission layer 30. The auxiliary layer may include a hole transport layer, a hole injection layer, an electron injection layer, and an electron transport layer for balancing electrons and holes.

The encapsulation substrate 50 may be made of glass, metal, or a polymer. The lower electrode 20, the organic emission layer 30, and the upper electrode 40 are sealed to prevent moisture and/or oxygen from permeating.

The antireflective film 80 may be disposed at a light-emitting side. For example, the antireflective film 80 may be disposed outside of the base substrate 10 in a bottom emission type in which light emits from the base substrate 10, outside of the encapsulation substrate 50 in a top emission type in which light emits from the encapsulation substrate 50, and outside both of the base substrate 10 and the encapsulation substrate 50 in a both-side emission type in which light emits from the base substrate 10 and the encapsulation substrate 50.

As described above, the antireflective film 80 includes a compensation film 60, a polarizing film 70, and an adhesion layer 65 positioned therebetween, and descriptions therefor are omitted here.

Hereinafter, the present disclosure is illustrated in more detail with reference to examples. However, these examples are exemplary, and the present disclosure is not limited thereto.

### Preparation Example 1

### Preparation of Adhesion Layer

60 parts by weight of butylacrylate (BA), 38 parts by weight of methylmethacrylate (MA), 2 parts by weight of butyl methacrylate (BMA), 0.2 parts by weight of 2,2′-azobisisobutyronitrile (AIBN), and 100 parts by weight of ethyl acetate are put in a 3-necked flask equipped with a cooler, an agitator, and a thermometer, and nitrogen is sufficiently substituted therein. This solution is agitated under a nitrogen atmosphere and reacted at 60° C. for 6 hours, obtaining an acrylic resin solution having a weight average molecular weight of 620,000 and an acid value of 4.0.

Then, 0.18 parts by weight of a solid xylylene diisocyanate trifunctional adduct (TD-75, Soken Chemical & Engineering Co., Ltd.) based on 100 parts by weight solids in the acrylic resin solution is added thereto, preparing an adhesive in a solution state.

The obtained adhesive in a solution state is respectively coated on a release polyester film (a thickness: 38 μm), and then heat-treated at 105° C. for 5 minutes to evaporate a solvent and dried to form each 10 μm-thick adhesion layer.

### Preparation Example 2

### Preparation of Adhesion Layer

84 parts by weight of butylacrylate (BA), 13 parts by weight of methylmethacrylate (MA), 3 parts by weight of acrylic acid (AA), 0.2 parts by weight of 2,2′-azobisisobutyronitrile (AIBN), and 100 parts by weight of ethyl acetate are put in a 3-necked flask equipped with a cooler, an agitator, and a thermometer, and then nitrogen is sufficiently substituted therein. This solution is agitated under a nitrogen atmosphere and reacted at 60° C. for 6 hours, obtaining an acrylic resin solution having a weight average molecular weight of 1,600,000. Then, 11 parts by weight of a solid xylylene diisocyanate trifunctional adduct (TD-75, Soken Chemical & Engineering Co., Ltd.) based on 100 parts by weight of a solid in this acrylic resin solution is added thereto, preparing an adhesive resin in a solution state.

The adhesive resin in a solution state is respectively coated on a release polyester films (a thickness: 38 μm), and then heat-treated at 105° C. for 5 minutes to evaporate a solvent and dried, forming each 10 μm-thick adhesion layer.

### Comparative Preparation Example 1

### Preparation of Adhesion Layer

90 parts by weight of butylacrylate (BA), 10 parts by weight of methylmethacrylate (MA), 0.2 parts by weight of 2,2′-azobisisobutyronitrile (AIBN), and 100 parts by weight of ethyl acetate are put in a 3-necked flask equipped with a cooler, an agitator, and a thermometer, and nitrogen is sufficiently substituted therein. This solution is agitated under a nitrogen atmosphere and reacted at 60° C. for 6 hours, obtaining an acrylic resin solution having a weight average molecular weight of 1,500,000. Then, 0.27 parts by weight of a solid xylylene diisocyanate trifunctional adduct (TD-75, Soken Chemical & Engineering Co., Ltd.) based on 100 parts by weight of the solids in the acrylic resin solution is added thereto, preparing an adhesive in a solution state.

The adhesive in a solution state is respectively coated on a release polyester film (a thickness: 38 μm), and heat-treated at 105° C. for 5 minutes to evaporate a solvent and dried, forming each 10 μm-thick adhesion layer.

### Example 1

### Preparation of Antireflective Film

A composition (A) for a core layer is prepared by mixing 1 part by weight of a dichroic dye represented by the following Chemical Formulae 1a to 1d with 100 parts by weight of a polyolefin polymer including 60 parts by weight of polypropylene (HU300, Samsung Total Petrochemicals Co., Ltd.) and 40 parts by weight of a polypropylene-ethylene copolymer (RJ581, Samsung Total Petrochemicals Co., Ltd.). Each dichroic dye is used as follows: 0.200 parts by weight of a dichroic dye represented by the following Chemical Formula 1a (yellow, λₘₐₓ=385 nm, dichroic ratio=7.0), 0.228 parts by weight of a dichroic dye represented by the following Chemical Formula 1b (yellow, λₘₐₓ=455 nm, dichroic ratio=6.5), 0.286 parts by weight of a dichroic dye represented by the following Chemical Formula 1c (red, λₘₐₓ=555 nm, dichroic ratio=5.1), and 0.286 parts by weight of a dichroic dye represented by the following Chemical Formula 1d (blue, λₘₐₓ=600 nm, dichroic ratio=4.5).

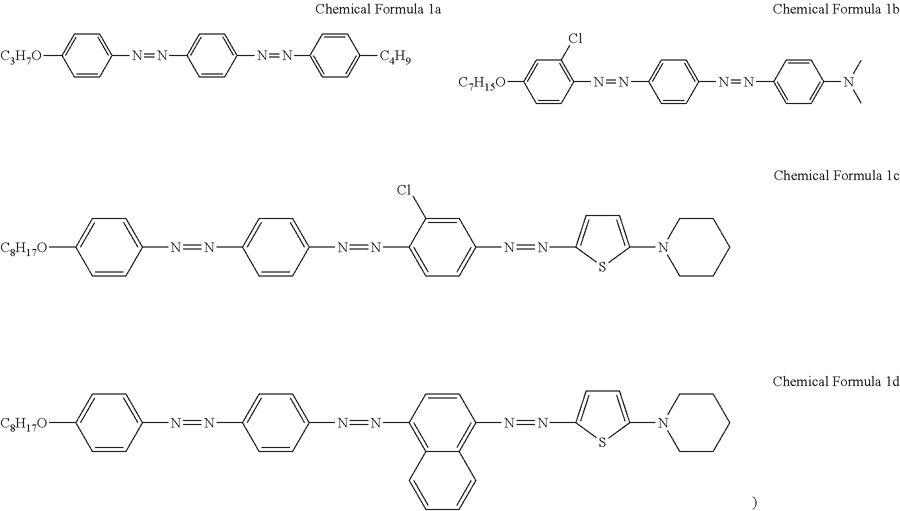

The mixture is melt-blended at about 200° C. by using an extruder (Process 11 parallel twin-screw extruder, ThermoFisher Scientific Inc.). Subsequently, the melt-blended mixture is formed into a film by using an extruder (a cast film extrusion line, Collin), manufacturing a sheet. The sheet is then elongated by 8 times in a uniaxial direction (using a tensile tester, Instron) at 125° C., manufacturing a polarizing film.

Then, the adhesion layer of Preparation Example 1 is positioned between the polarizing film and a polycarbonate compensation film and bonded therewith through lamination, manufacturing an antireflective film.

### Example 2

### Preparation of Antireflective Film

An antireflective film is manufactured according to the same method as Example 1, except for using the adhesion layer of Preparation Example 2 instead of the adhesion layer of Preparation Example 1.

### Comparative Example 1

### Preparation of Antireflective Film

An antireflective film is manufactured according to the same method as Example 1, except for using the adhesion layer of Comparative Preparation Example 2 instead of the adhesion layer of Preparation Example 1.

Peeling Strength of Adhesion Layer

Each adhesion layer of Preparation Examples 1 and 2 and Comparative Example 1 is attached to a 100 μm-thick polyethylene terephthalate (PET) release film, respectively manufacturing an adhesive film. The adhesive film is attached to a film as a substrate. Herein, the substrate includes a polyolefin polarizing film coated with a corona on the surface and a polycarbonate retardation film. One hour after the attachment, peeling strength of a sample is measured by cutting the sample into a size of 25 mm×200 mm and peeling the adhesion layer from the substrate at a speed of 300 mm/min at an angle of 180° with a texture analyzer. The peeling strength is respectively measured at room temperature (25° C.) and a high temperature (70° C.). The results are provided in Table 1.

Storage Modulus

Each adhesive film is manufactured by respectively attaching the adhesion layers of Preparation Examples 1 and 2 and Preparation Comparative Example 1 on a 100 μm-thick PET film. Several adhesive films are overlapped to be 500 μm thick, and then cut into a disk having a diameter of 8 mm, manufacturing a sample. Then, storage modulus (G′) and loss modulus (G″) of the sample are measured by performing a frequency sweep test under a shear stress of 200 Pa at 25° C. and a frequency ranging from 0.1 to 100 rad/s and using a storage modulus-measuring instrument (Anton Paar). A ratio of G″/G′ is calculated and is shown in Table 1.

Acid Value

The amount of a potassium hydroxide ethanol solution needed to neutralize a sample is measured by dissolving the sample in a mixed solvent (diethylether ethanol in a volume ratio of 2:1) and potential difference-titrated with a potassium hydroxide ethanol solution with a concentration of about 0.5 mol/l by using an automatic potential difference titration device. The acid value of an acrylate polymer is calculated according to the following Equation 2.

Acid value=(B×f×56.11)/S Equation 2

In Equation 2, the B indicates the amount in milliliters (ml) of the 0.5 mol/l potassium hydroxide ethanol solution used for the titration, the f indicates a factor of the 0.5 mol/l potassium hydroxide ethanol solution, and the S indicate the mass in grams (g) of a solid in the sample.

The measured acid value is shown in the following Table 1.

TABLE 1

| | | | | Comparative |
|---|---|---|---|---|
| | | Preparation | Preparation | Preparation |
| | | Example 1 | Example 2 | Example 1 |
| Weight average molecular | | 620000 | 1600000 | 1500000 |
| weight (Mw) | | | | |
| Acid value | | 4.0 | 13.8 | 0 |
| Peeling strength | Polarizing | 1320 | 850 | 240 |
| (gf/25 mm) at | film | | | |
| room | Compen- | 770 | 1400 | 450 |
| temperature | sation film | | | |
| (25° C.) | | | | |
| Peeling strength | polarizing | 1830 | 400 | 140 |
| (gf/25 mm) at | film | | | |
| high temperature | compen- | 1900 | 1760 | 400 |
| | sation film | | | |

| | | | |
|---|---|---|---|
| G″/G′ | 1.65 | 0.904 | 0.434 |

Static Bending Test

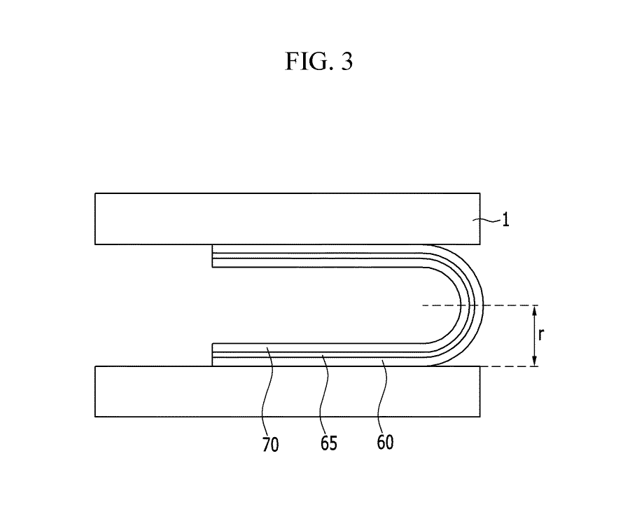

FIG. 3 is a plan view showing a bending test experiment method of the antireflective films according to Examples 1 and 2 and Comparative Example 1. As shown in FIG. 3, the antireflective films according to Examples 1 and 2 and Comparative Example 1 are respectively bent and fixed between two plates 1, to have a curvature radius (r) ranging from 3 mm and 5 mm. The antireflective films in the bent state are respectively allowed to stand for 24 hours, and also for 250 hours, at 60° C. under a condition of relative humidity of 95%. After twenty-four hours, retardation in the bent region of each antireflective film is measured by using optical measurement equipment (KOBRA). The results are shown in Table 2.

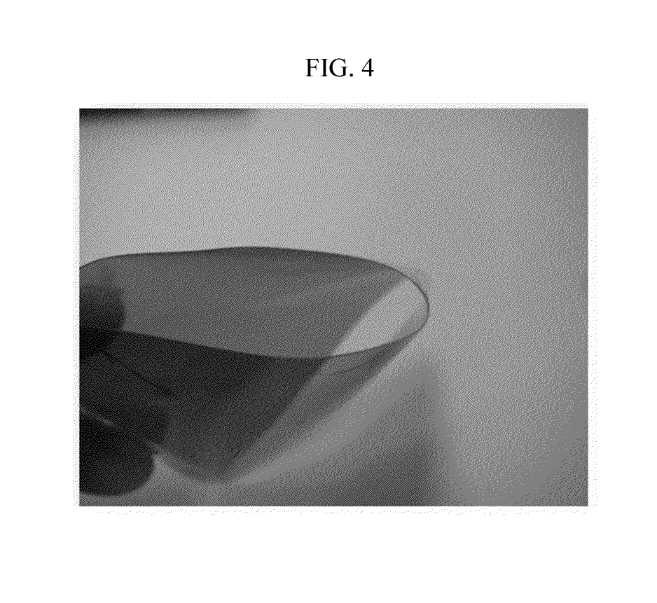

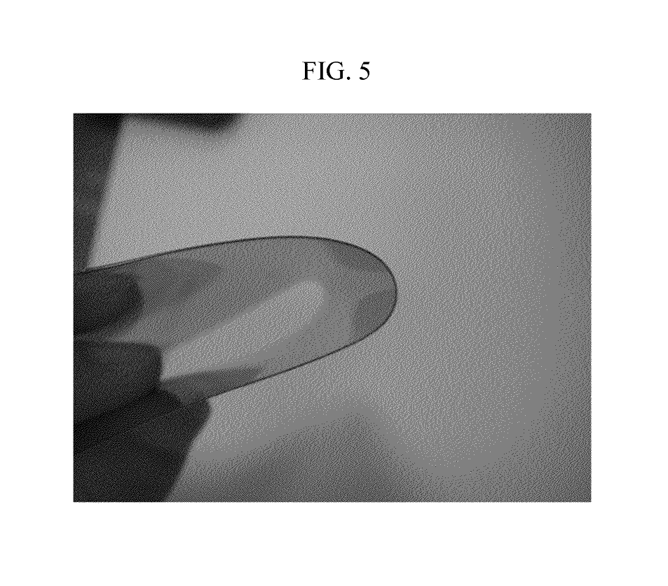

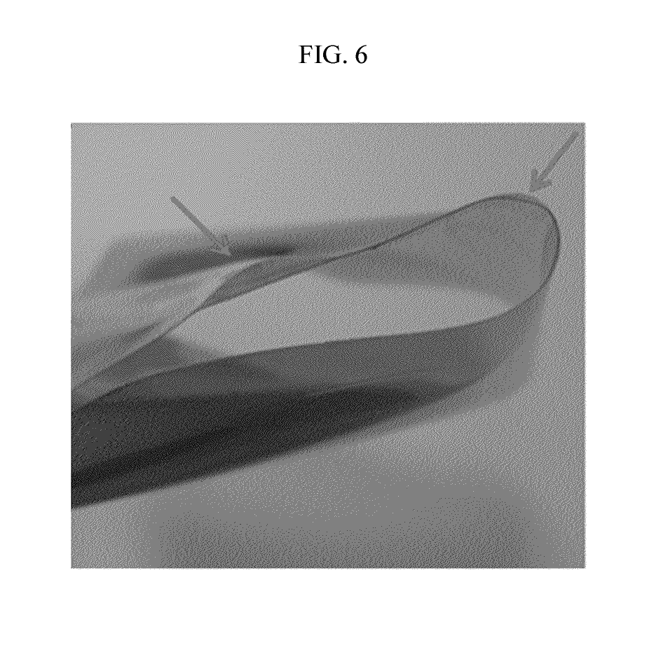

After two hundred and fifty hours, the bent region of each antireflective film is observed with the naked eye to determine if it is peeled on the interface or if vapor is generated or not, and photographs of each are provided in FIGS. 4, 5, and 6. FIG. 4 is a photograph showing the cross-section of the antireflective film of Example 1 in a curvature radius state of 3 mm after being allowed to stand at 60° C. under relative humidity of 95% for 250 hours. FIG. 5 is a photograph showing the cross-section of the antireflective film of Example 2 in a curvature radius state of 5 mm after being allowed to stand at 60° C. under relative humidity of 95% for 250 hours. FIG. 6 is a photograph showing the cross-section of the antireflective film of Comparative Example 1 in a curvature radius state of 5 mm after being allowed to stand at 60° C. under relative humidity of 95% for 250 hours.

TABLE 2

| | | | | Comparative |
|---|---|---|---|---|
| | | Example 1 | Example 2 | Example 1 |
| 60° C./ | Curvature radius 5 mm | 7.81 | 3.44 | 10.6 |
| 95% RH/ | Curvature radius 3 mm | 9.47 | 5.49 | 11.5 |
| 24 hours | | | | |

Referring to the results of Table 2, the antireflective films according to Examples 1 and 2 show a retardation change of less than or equal to 10% after the bending test. In addition, the antireflective films of Examples 1 and 2 show neither peeling on the interface nor vapor after the bending test in FIGS. 4, 5, and 6, but the antireflective film of Comparative Example 1 shows peeling on the interface.

The antireflective film of Example 1 is fixed in a device shown in FIG. 3 and bent, and is then allowed to stand at 85° C. for 24 hours and for 250 hours. Then, retardation of the bent region of the antireflective film after twenty-four hours is measured by using optical measurement equipment (KOBRA). The result is provided in Table 3.

TABLE 3

| | | Example 1 |
|---|---|---|
| 85° C. | Curvature radius 5 mm | 6.62 |
| 24 hours | Curvature radius 3 mm | 7.90 |

Referring to Table 3, the antireflective film of Example 1 shows a retardation change of less than or equal to 10% after the bending test. In addition, the antireflective film shows neither peeling on the interface nor vapor after the bending test.

Dynamic Bending Test

The antireflective film of Example 1 is repeatedly folded to a curvature radius of 3 mm and unfolded at room temperature (25° C.). After repeating a predetermined number of folding and unfolding repetitions, (200,000), the antireflective film is observed with the naked eye to determine if it is peeled on the interface or has vapor. As a result, no delamination phenomenon on the interface is found. The antireflective film shows a retardation change relative to its initial retardation in the bent region when measured with optical measurement equipment (KOBRA) of 5.41%.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An antireflective film for a flexible display device, comprising
a polarizing film, a compensation film, and an adhesion layer positioned therebetween,
wherein the antireflective film has a retardation change (ΔR) relative to initial retardation (R₀) satisfying the following Equation 1 when bent with a curvature radius (r) of greater than or equal to about 3 mm:
$$\frac{Δ R}{{R}_{0}} \times 100 \leq 10 \% . \qquad Equation 1$$

2. The antireflective film for a flexible display device of claim 1, wherein the polarizing film comprises a dichroic dye and a polymer.

3. The antireflective film for a flexible display device of claim 1, wherein the compensation film is a quarter wave (λ/4) retardation film.

4. The antireflective film for a flexible display device of claim 1, wherein the adhesion layer comprises a polymeric adhesive comprising a polymer selected from an acrylate polymer, a methacrylate polymer, a urethane polymer, a polyisobutylene polymer, a styrene butadiene polymer, a polyvinylether polymer, an epoxy polymer resin, a melamine polymer, a polyester polymer, a phenolic polymer, a silicone polymer, or a combination thereof.

5. The antireflective film for a flexible display device of claim 1, wherein the polymeric adhesive is formed from a resin comprising at least one functional group selected from a hydroxy group, a carboxyl group, and a nitrogen-containing functional group.

6. The antireflective film for a flexible display device of claim 1, wherein the polymeric adhesive is cross-linked with at least one cross-linking agent selected from an isocyanate compound, an epoxy compound, an aziridine compound, and a metal chelate compound.

7. The antireflective film for a flexible display device of claim 1, wherein the polymeric adhesive has a weight average molecular weight (Mw) from about 500,000 to about 1,800,000 and an acid value from about 0.5 to about 16.

8. The antireflective film for a flexible display device of claim 1, wherein the polymeric adhesive has a weight average molecular weight of greater than or equal to about 1,500,000 and an acid value of greater than or equal to about 4.5.

9. The antireflective film for a flexible display device of claim 1, wherein the adhesion layer has a 180° peeling strength of greater than or equal to about 800 gf/25 mm from a polyolefin substrate but greater than or equal to about 700 gf/25 mm from a polycarbonate substrate, when tested at room temperature.

10. The antireflective film for a flexible display device of claim 1, wherein the adhesion layer has a 180° peeling strength of greater than or equal to about 400 gf/25 mm from a polyolefin substrate and about 1700 gf/25 mm from a polycarbonate substrate at a high temperature.

11. The antireflective film for a flexible display device of claim 1, wherein the adhesion layer has a ratio (G″/G′) of a loss modulus (G″, ω=100) of greater than or equal to about 0.5 relative to a storage modulus (G′, ω=0.1) under a thickness condition of about 500 μm.

12. A flexible display device comprising
a display panel and an antireflective film formed on at least one side of the display panel,
wherein the antireflective film comprises a polarizing film, a compensation film, and an adhesion layer positioned therebetween, and
a retardation change (ΔR) relative to the initial retardation R₀ of the antireflective film satisfies the following Equation 1 when the antireflective film is bent with a curvature radius (r) of greater than or equal to about 3 mm:
$$\frac{Δ R}{{R}_{0}} \times 100 \leq 10 \% . \qquad Equation 1$$

13. The flexible display device of claim 12, wherein the polarizing film comprises a dichroic dye and a polymer.

14. The flexible display device of claim 12, wherein the compensation film is a quarter wave (λ/4) retardation film.

15. The flexible display device of claim 12, wherein the adhesion layer comprises a polymeric adhesive selected from an acrylate polymer, a methacrylate polymer, a urethane polymer, a polyisobutylene polymer, a styrene butadiene polymer, a polyvinylether polymer, an epoxy polymer, a melamine polymer, a polyester polymer, a phenolic polymer, a silicone polymer, or a combination thereof.

16. The flexible display device of claim 12, wherein the polymeric adhesive is derived from a resin comprising at least one functional group selected from a hydroxy group, a carboxyl group, and a nitrogen-containing functional group.

17. The flexible display device of claim 12, wherein the polymeric adhesive is cross-linked with at least one cross-linking agent selected from an isocyanate compound, an epoxy compound, an aziridine compound, and a metal chelate compound.

18. The flexible display device of claim 12, wherein the polymeric adhesive has a weight average molecular weight (Mw) ranging from about 500,000 to about 1,800,000 and an acid value ranging from about 0.5 to about 16.

19. The flexible display device of claim 12, wherein the polymeric adhesive has a weight average molecular weight of greater than or equal to about 1,500,000 and an acid value of greater than or equal to about 4.5.

20. The flexible display device of claim 12, wherein the adhesion layer has a 180° peeling strength of greater than or equal to about 800 gf/25 mm from a polyolefin-based substrate and of greater than or equal to about 700 gf/25 mm from a polycarbonate substrate at room temperature.

21. The flexible display device of claim 12, wherein the adhesion layer has 180° peeling strength of greater than or equal to about 400 gf/25 mm from a polyolefin substrate and of greater than or equal to about 1700 gf/25 mm from a polycarbonate substrate at a high temperature.

22. The flexible display device of claim 12, wherein the adhesion layer has a ratio (G″/G′) of a loss modulus (G″, ω=100) of greater than or equal to about 0.5 relative to a storage modulus (G′, ω=0.1) under a thickness condition of about 500 μm.
